(19) United States
(12) Patent Application Publication
(10) Pub. No.: US 2025/0350458 A1
(43) Pub. Date: Nov. 13, 2025

(54) SYSTEM FOR CONTENT EDITING PREVENTION USING BLANK NON-FUNGIBLE TOKEN FRAME INSERTION

(71) Applicant: BANK OF AMERICA CORPORATION, CHARLOTTE, NC (US)

(72) Inventors: Shailendra Singh, Thane West (IN); Saurabh Gupta, Dwarka (IN)

(73) Assignee: BANK OF AMERICA CORPORATION, CHARLOTTE, NC (US)

(21) Appl. No.: 18/658,003

(22) Filed: May 8, 2024

(51) Int. Cl. H04L 9/32

(52) U.S. Cl. CPC H04L 9/32

(57) ABSTRACT

Systems, computer program products, and methods are described herein for the systematic splicing of original content into frames and the insertion of blank non-fungible token (NFT) tagged frames at critical points within the multimedia preventing Artificial Intelligent (AI) tool modification of an original multimedia. The invention is configured to prevent content editing using blank NFT token frame insertion, providing NFT integration for all multimedia digitally rendered. Each multimedia frame is associated with a unique NFT, creating a digital fingerprint for authentication. Blank NFT frames are strategically inserted throughout the multimedia based on criticality of the frame to the overall multimedia, forming a grid pattern. The system implements distributed ledger technology where NFT information is stored on a ledger for transparency and immutability. Upon source key recognition replacement frames will replace blank NFT frames in real time through consortium network to render at a releasing entity end point.

### BACKGROUND

Advancements in Artificial Intelligence (AI) have brought forth advancements in content creation and potential malicious use of AI-based tools for manipulation of multimedia to product inappropriate or objectionable content that is unknowingly digested. As such a need exists for a content editing prevention network using blank non-fungible token (NFT) insertion.

### SUMMARY

The following presents a simplified summary of one or more embodiments of the present invention, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

The invention comprises a system, method, and computer program product for multimedia blank non-fungible token (NFT) frame insertion comprising: accepting an original multimedia file for deployment of a multimedia on a mainstream digital network; segmenting the original multimedia file associated with the multimedia into static frames; selecting a program residing in the distributed computing network based platform for identification of critical static frames within the original multimedia file and remove the critical static frames; replacing the critical static frames with blank NFT frames by inputting the blank NFT frames systematically positioned within static frames of the multimedia content and the critical static frames; storing metadata on an NFT associated with the blank NFT frames for verifying the blank NFT frame; receiving an authentic request to render and release the multimedia; replacing, in real-time the blank NFT frames using a source key from a producing entity across a consortium network; and digitally displaying the multimedia on a releasing entity platform.

In some embodiments, the invention further comprises preventing replacement of the blank NFT frames upon identification of an artificial intelligent (AI) tool attempting to modify the multimedia without the source key, whereby preventing the rendering of the multimedia due to the blank NFT frames.

In some embodiments, after determining the request to render is from the producing entity by authentication of the source code perform a repository check confirming smart contract content approval prior to digital launch of the multimedia.

In some embodiments, the metadata on an NFT associated with the blank NFT frames further comprises information about a location of the blank NFT frame within the multimedia, information about a previous blank NFT frame within the multimedia, information about a future blank NFT frame within the multimedia, and a smart contract.

In some embodiments, the smart contract comprises a content approval mechanism that only allows rendering and releasing of the multimedia within a time and content scope.

In some embodiments, the invention further comprises generation and deployment of the consortium network allowing for a direct communication linkage between a producing entity and a releasing entity to render the multimedia by replacing the blank NFT frames with correct critical static frames for digital release.

In some embodiments, the critical static frames further comprise frames of the multimedia where a critical action or critical message of the overall multimedia occurs within that frame. In some embodiments, the multimedia is a video stream.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIGS. 1A-1C illustrate technical components of an exemplary distributed computing environment for content editing prevention using blank non-fungible token (NFT) frame insertion, in accordance with an embodiment of the invention;

FIGS. 2A-2B illustrate technical components of the NFT construction for NFT frame insertion, in accordance with an embodiment of the invention;

FIG. 3 illustrates a process flow of entity data processing for content editing prevention using blank NFT frame insertion, in accordance with an embodiment of the invention;

FIG. 4 illustrates a process flow for content editing prevention using blank NFT frame insertion, in accordance with an embodiment of the invention; and

FIG. 5 illustrates a process flow for content allowance using blank NFT frame insertion, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, an “engine” may refer to core elements of an application, or part of an application that serves as a foundation for a larger piece of software and drives the functionality of the software. In some embodiments, an engine may be self-contained, but externally-controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

Malicious editing of multimedia content such as videos to edit the content to change the intent or message of the multimedia content is on the rise, especially with the improvements in AI tools to perform the edits to make the multimedia appear to be original but provide inappropriate or malicious message or advertisement.

Accordingly, the invention divides the static frames of a multimedia content and inserts blank NFT frame with the static frames of the multimedia content. The final content, when displayed publicly via the internet or other media platform will render completely only if the blank NFT frames are replaces with actual static frames of the multimedia coming from the respective owner of the multimedia. Blank NFT frames are being replaced in real-time as the video is being rendered with the correct static frames from the producing entity.

The blank NFT frames are inserted and replace original specific frames based on scoring of the frames content. In this way, the system replaces critical frames in critical locations of the multimedia with blank NFT frames. These frames may include ones with critical information or the like. The blank NFT frame is not a simple blank NFT frame, each blank NFT frame hosts metadata regarding the blank NFT frames prior to it and the next blank NFT frame after it. Which prevents actors from attempting to recreate the content.

The system further comprises a repository check. The repository check reviews frames received by the producing entity for personal information or unapproved information determined based on a smart contract provided by the producing entity, before replacing the blank NFT frames and rendering multimedia for display. In this way, the producing entity may provide rules around multimedia output, such as the channel, timing, content, and the like. The system may generate smart contracts for the requirements for each multimedia. Prior to releasing the multimedia on a releasing entity platform, the system performs a repository check, checking for the rules associated with the multimedia prior to releasing entity launch.

However, if a malicious actor is trying to download the multimedia in order to use an AI tool to modify the multimedia content, the actor will always receive the content with the blank NFT frames. An AI tool is not able to remove the blank NFT frame nor can the blank NFT frame be replaced. The blank NFT frames are each designed to only be replaced using a source key from the owner system. Even if the AI tool is able to decipher the content, the blank NFT frame creates a blockchain linkage rendering it impossible to display on a releasing entity platform.

What is more, the present invention provides a technical solution to a technical problem. As described herein, the technical problem includes AI utilization for deep fake manipulation of multimedia, interrupting and modifying original content and storing the same as original. The technical solution presented herein allows for the splicing of original content into frames and the insertion of blank NFT tagged frames at critical points within the multimedia which renders AI modification of an original multimedia unrenderable. If the content is original and not modified, the blank NFT frames are replaced with the original correct frames in real-time for a releasing entity to present the original, unaltered multimedia. In particular, inserting blank NFT frames is an improvement over existing solutions to the AI manipulation of original multimedia providing (i) with fewer steps to achieve the solution, thus reducing the amount of computing resources, such as processing resources, storage resources, network resources, and/or the like, that are being used, (ii) providing a more accurate solution to problem, thus reducing the number of resources required to remedy any errors made due to a less accurate solution, (iii) removing manual input and waste from the implementation of the solution, thus improving speed and efficiency of the process and conserving computing resources, (iv) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

The rise of deep-fake technology allows malicious actors to create hyper-realistic multimedia by seamlessly swapping or altering the content of the footage. This has serious implications for misinformation, identity misappropriation, and the like. The use of malicious AI in editing content enables the creation of deceptive videos and images, contributing to misinformation and disinformation campaigns. Furthermore, these AI-based tools can be exploited to manipulate multimedia such as images, videos, or sounds that may lead to the creation of compromising content. AI driven manipulations can be leveraged to create content that facilitates social engineering misappropriation. By providing misleading narratives, bad actors may exploit individuals or organizations for malicious purposes. The ability to generate highly convincing manipulated content challenges the authenticity of media. Therefore, a need exists to identify, tag, and/or prevent to AI-based manipulation of multimedia content. This is currently a challenge because individual systems would have to continuously monitor or tag original multimedia and continually scan the internet or other outputs to make sure all multimedia outputs match the original. This requires significant computing power that is not feasible for system operations.

The invention creates a system for content editing prevention using blank NFT token frame insertion, which prevents the malicious editing of any multimedia content in the digital world using blank NFT frames and content insertion technology. The system provides NFT integration for all multimedia, including videos, images, and sounds assimilated in the digital world. Each multimedia frame is associated with a unique NFT, creating a digital fingerprint for authentication. Blank NFT frames are strategically inserted throughout the multimedia based on criticality of the frame to the overall multimedia, forming a grid pattern. The system implements distributed ledger technology where NFT information is stored on a ledger for transparency and immutability. Smart contracts facilitate the dynamic replacement of blank NFT frames with approved frames. Approved frames will be received in real time from a producing entity through a consortium network to a releasing entity only when the multimedia is being rendered. If there is an attempt to edit/download the multimedia, the editor is required to replace the blank NFT frames with the real critical frames that are missing in order to render the multimedia. If the editor is not able to produce the matching NFT token frame for the multimedia, it will not be complete and it will be noneditable. On each attempt of multimedia edit, the system will look for valid NFT frame and will not let the editing occur without the right NFT frame produced.

Each blank NFT frame is positioned within the multimedia based on select criteria from the system content approval mechanism. The content approval mechanism identifies critical frames within the multimedia content based on a content approval scoring mechanism where frames with unobjectionable content will have lowest edit score.

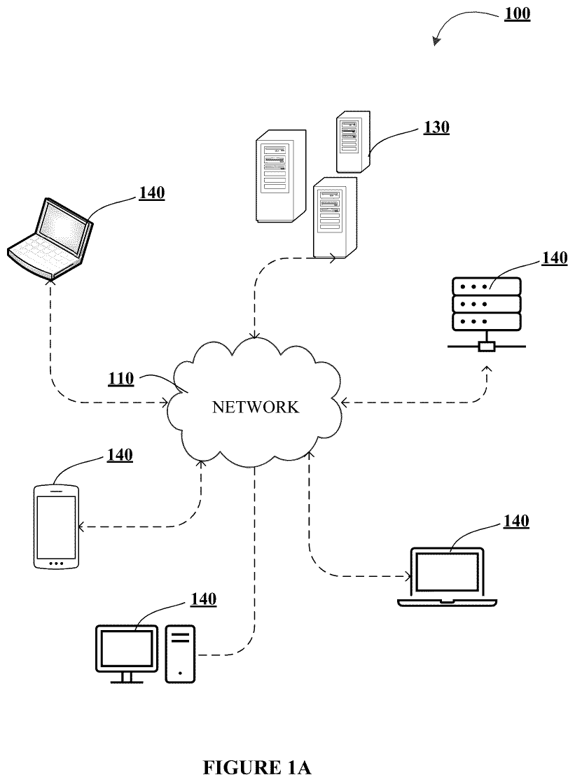

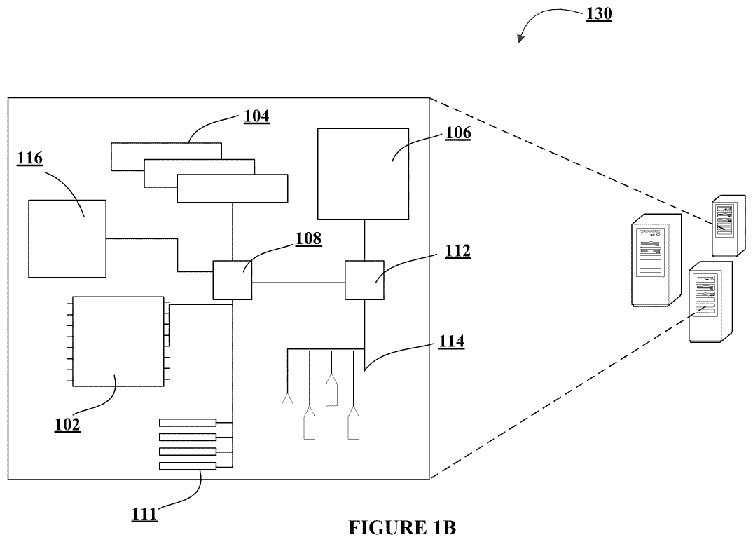

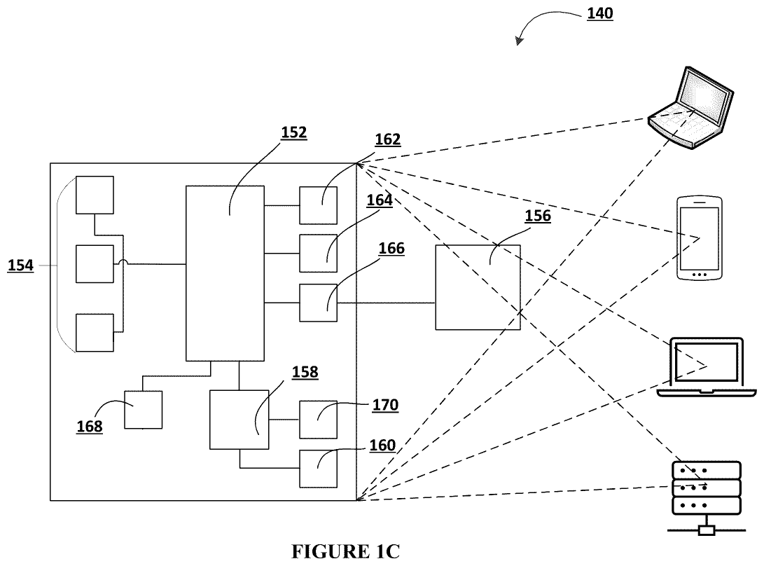

FIGS. 1A-1C illustrate technical components of an exemplary distributed computing environment for content editing prevention using blank NFT frame insertion 100, in accordance with an embodiment of the invention. As shown in FIG. 1A, the distributed computing environment 100 contemplated herein may include a system 130, an end-point device(s) 140, and a network 110 over which the system 130 and end-point device(s) 140 communicate therebetween. The system 130 may be associated with a producing entity, the end-point device(s) may be a releasing entity or end user viewing the multimedia.

FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the inventions described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the invention. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the invention. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation—and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert it to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

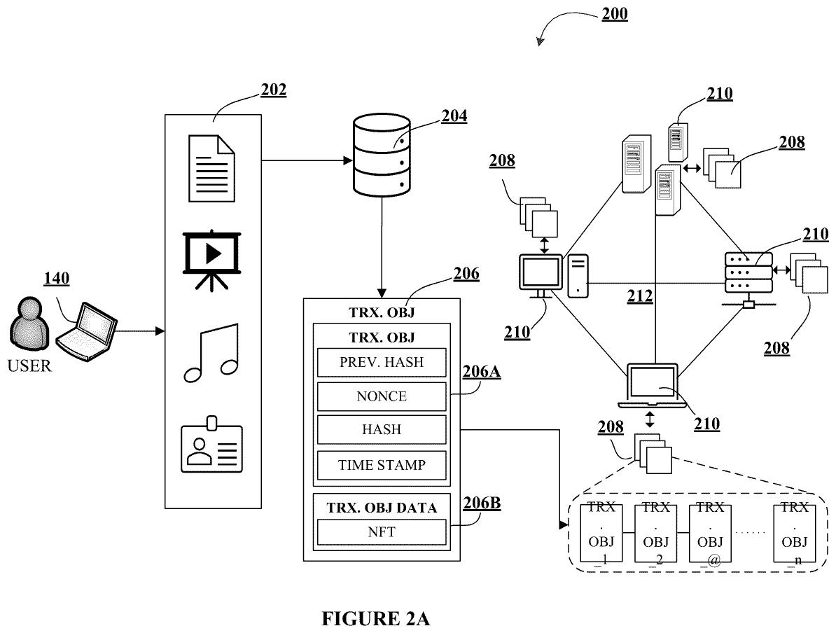

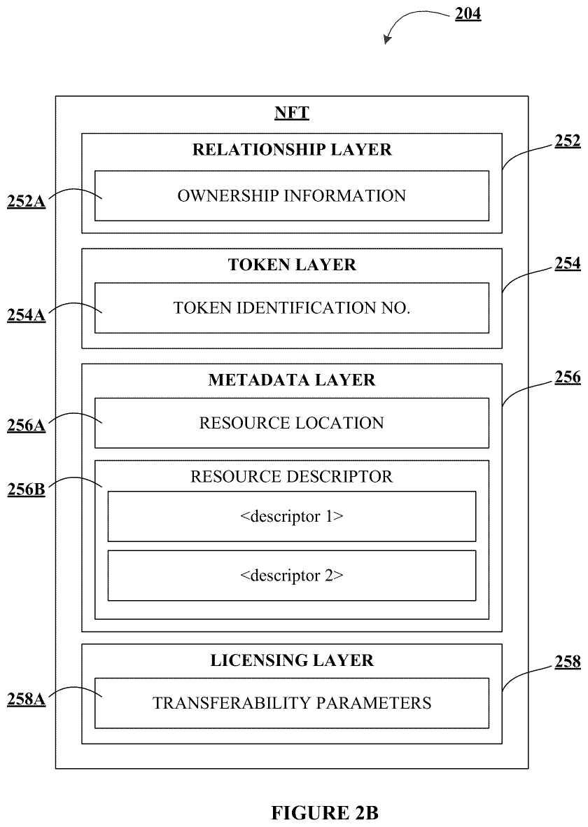

FIGS. 2A-2B illustrate technical components of the NFT construction for NFT frame insertion 200, in accordance with an embodiment of the invention. An NFT is a cryptographic record (referred to as “tokens”) linked to a resource. An NFT is typically stored on a distributed ledger that certifies ownership and authenticity of the resource, and exchangeable in a peer-to-peer network. FIG. 2A illustrates an exemplary process of creating an NFT 200, in accordance with an embodiment of the invention. As shown in FIG. 2A, to create or “mint” an NFT, a user (e.g., NFT owner) may identify, using a user input device 140, resources 202 that the user wishes to mint as an NFT. Typically, NFTs are minted from digital objects that represent both tangible and intangible objects. These resources 202 may include a piece of art, music, collectible, virtual world items, videos, real-world items such as artwork and real estate, or any other presumed valuable object. These resources 202 are then digitized into a proper format to produce an NFT 204. The NFT 204 may be a multi-layered documentation that identifies the resources 202 but also evidences various transaction conditions associated therewith, as described in more detail with respect to Figure A.

To record the NFT in a distributed ledger, a transaction object 206 for the NFT 204 is created. The transaction object 206 may include a transaction header 206A and a transaction object data 206B. The transaction header 206A may include a cryptographic hash of the previous transaction object, a nonce-a randomly generated 32-bit whole number when the transaction object is created, cryptographic hash of the current transaction object wedded to the nonce, and a time stamp. The transaction object data 206B may include the NFT 204 being recorded. Once the transaction object 206 is generated, the NFT 204 is considered signed and forever tied to its nonce and hash. The transaction object 206 is then deployed in the distributed ledger 208. At this time, a distributed ledger address is generated for the transaction object 206, i.e., an indication of where it is located on the distributed ledger 208 and captured for recording purposes. Once deployed, the NFT 204 is linked permanently to its hash and the distributed ledger 208, and is considered recorded in the distributed ledger 208, thus concluding the minting process

As shown in FIG. 2A, the distributed ledger 208 may be maintained on multiple devices (nodes) 210 that are authorized to keep track of the distributed ledger 208. For example, these nodes 210 may be computing devices such as system 130 and end-point device(s) 140. One node 210 may have a complete or partial copy of the entire distributed ledger 208 or set of transactions and/or transaction objects on the distributed ledger 208. Transactions, such as the creation and recordation of a NFT, are initiated at a node and communicated to the various nodes. Any of the nodes can validate a transaction, record the transaction to its copy of the distributed ledger, and/or broadcast the transaction, its validation (in the form of a transaction object) and/or other data to other nodes.

FIG. 2B illustrates an exemplary NFT 204 as a multi-layered documentation of a resource, in accordance with an embodiment of an invention. As shown in FIG. 2B, the NFT may include at least relationship layer 252, a token layer 254, a metadata layer 256, and a licensing layer 258. The relationship layer 252 may include ownership information 252A, including a map of various users that are associated with the resource and/or the NFT 204, and their relationship to one another. For example, if the NFT 204 is purchased by buyer B1 from a seller S1, the relationship between B1 and S1 as a buyer-seller is recorded in the relationship layer 252. In another example, if the NFT 204 is owned by O1 and the resource itself is stored in a storage facility by storage provider SP1, then the relationship between O1 and SP1 as owner-file storage provider is recorded in the relationship layer 252. The token layer 254 may include a token identification number 254A that is used to identify the NFT 204. The metadata layer 256 may include at least a file location 256A and a file descriptor 256B. The file location 256A may provide information associated with the specific location of the resource 202. Depending on the conditions listed in the smart contract underlying the distributed ledger 208, the resource 202 may be stored on-chain, i.e., directly on the distributed ledger 208 along with the NFT 204, or off-chain, i.e., in an external storage location. The file location 256A identifies where the resource 202 is stored. The file descriptor 256B may include specific information associated with the source itself 202. For example, the file descriptor 256B may include information about the supply, authenticity, lineage, provenance of the resource 202. The licensing layer 258 may include any transferability parameters 258B associated with the NFT 204, such as restrictions and licensing rules associated with purchase, sale, and any other types of transfer of the resource 202 and/or the NFT 204 from one person to another. Those skilled in the art will appreciate that various additional layers and combinations of layers can be configured as needed without departing from the scope and spirit of the invention.

The system provides a complex technical procedure utilizing blank NFT frame based content scoring technology powered secure engine for prevention of AI based malicious content editing, that prevents malicious editing of any multimedia content in the digital world using blank NFT frames and content scoring technology. The system splices multimedia and enables NFT integration for all the multimedia in the digital world. Each frame is associated with a unique NFT, creating a digital fingerprint for authentication. Blank NFT frames are strategically inserted throughout the video, forming a grid pattern based on criticality of the frame to the overall multimedia content.

A distributed ledger stores NFT information associated with the frame. The NFT information also contains metadate comprising the location of the blank NFT frame within the multimedia content, such as information about the blank NFT frame before and after, as well as the information about the frames next to the blank NFT frame. Smart contracts facilitate the dynamic replacement of blank frames with approved frames. Approved frames will be received in real time from a production entity via a consortium network and will allow the complete multimedia to be rendered.

If a bad actor attempts to download or edit the video, the bad actor will notice missing frames, which are represented by the blank NFT frames. The only way to product the matching NFT frames with original content instead of the blank NFT frames is to receive the frames from the producing entity via a consortium network. If the editor is not able to produce the matching NFT token frame for the video, it will not be complete and it will be noneditable. On each attempt of video edit, the system requires a valid NFT frame and will not let the editing be performed until the right NFT frame is produced.

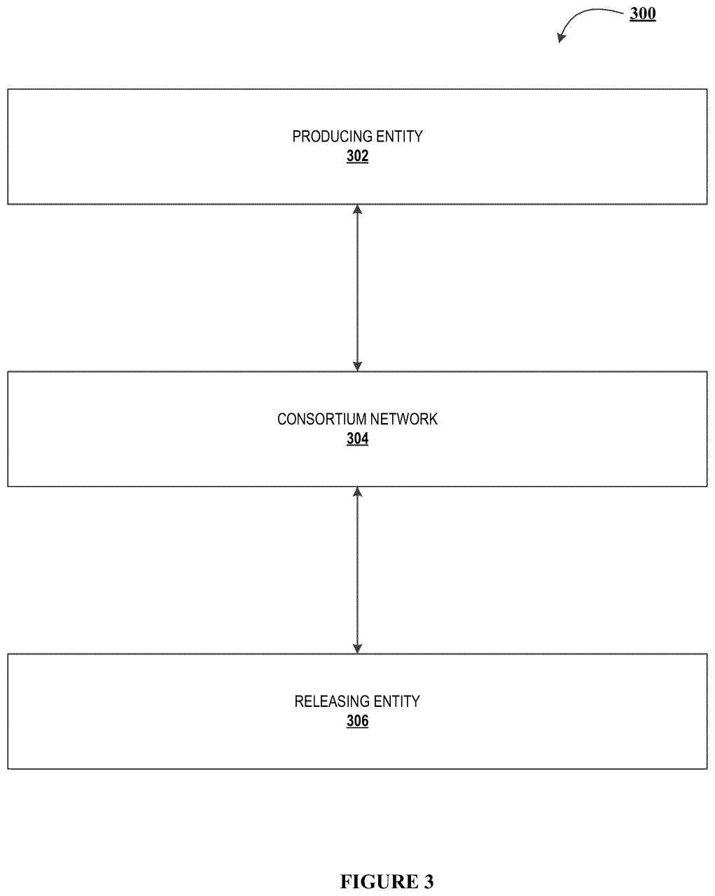

FIG. 3 illustrates a process flow of entity data processing for content editing prevention using blank NFT frame insertion 300, in accordance with an embodiment of the invention. As illustrated in FIG. 3, there is a producing entity 302, a consortium network 304, and a releasing entity 306.

The producing entity 302 may be the entity that produces the original multimedia for releasing. This could be a video, image, audio segment, or the like. The multimedia for releasing may be for promotion, entertainment, or the like. The producing entity 302 may be an individual, group of individuals, entity, or the like. The producing entity may have systems and devices to produce multimedia. Furthermore, the producing entity, as described further below, may work with the consortium network 304 and the releasing entity 306 for the insertion of blank NFT frames and the insertion of original frames in place of the blank NFT frames when approved and rendered.

The releasing entity 306 may be a social media platform, a television platform, a streaming platform, or the like that may release multimedia content digitally. The releasing entity 306 only releases rendered complete multimedia that has no blank NFT frames associated with the multimedia that is being released and rendered by the releasing entity 306.

The releasing entity 306 and the producing entity 302 are associated with a consortium network 304. The consortium network 304 creates a development format such that the releasing entity 306 and the producing entity 302 can communicate in real time to remove blank NFT frames and replace with correct static frames.

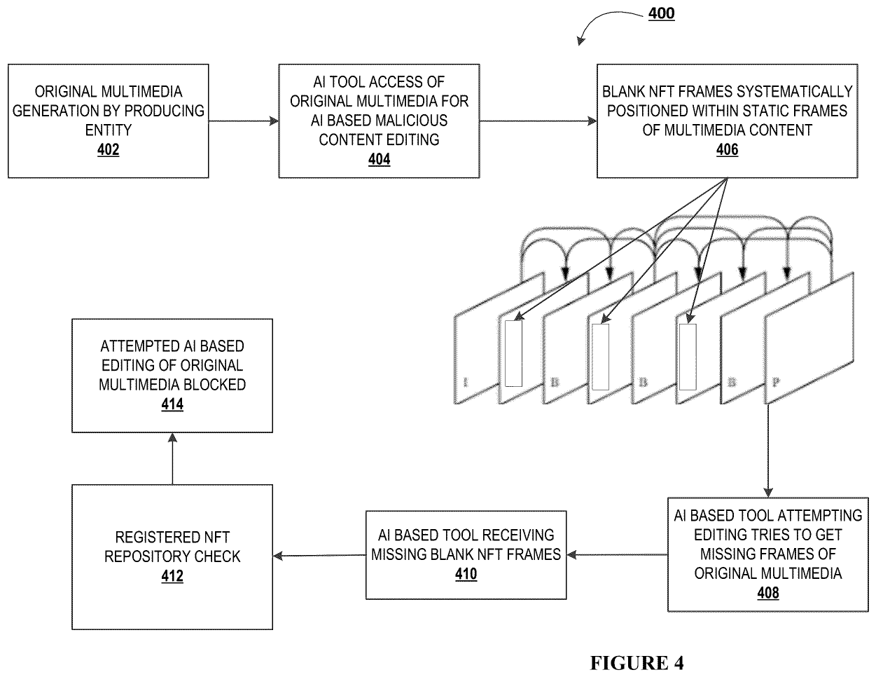

FIG. 4 illustrates a process flow for content editing prevention using blank NFT frame insertion 400, in accordance with an embodiment of the invention. As illustrated in block 402, the process 400 is initiated by generating the original multimedia by the producing entity. The multimedia may be a video stream, digital image, sound segment, or the like. The system may parse the multimedia into individual frames of the multimedia. The system scores each individual frame to determine which frames are most critical to the overall multimedia. The scoring comprises identifying the frames that include a critical message, image, location within the multimedia, or the like. As illustrated in block 406, the process continues by inputting the blank NFT frames systematically positioned within the static frames of the multimedia content. The blank NFT frames contain an NFT tag. The remaining portion of the frame of the multimedia is blank. As such, if an individual without the source key from the producing entity cannot remove the black frames and it will render the entire multimedia unreadable. Furthermore, if an AI tool attempts to modify the multimedia, the AI tool cannot remove the blank frames, which again would lead to an unrenderable modified multimedia. The NFT tag associated with each systematically positioned frame includes metadate to insure the location of the blank NFT frame and the correct positioning for rendering after introduction of the source key.

As illustrated in block 404, the process 400 continues with an AI tool attempted to access the original multimedia. In this way, the multimedia is accessed by a party outside of the producing or releasing party and is attempted to use one or more AI tools to manipulate the original content. As illustrated in block 408, the AI based tool that is attempting to perform the editing tries to get the missing frames from the original multimedia. The missing frames are then presented to the AI based tool as blank MFT frames since the request didn't provide the source key, as illustrated in block 410.

As illustrated in block 412, the process 400 continues by performing a repository check. The repository check checks the existing NFT repository and verifies if the new frames have any personal, objectionable, or unapproved content. The repository check performs a check based on the producing entity smart contract to confirm the timing, the contents, and the like of the multimedia matches the producing entity rules assigned to the multimedia. As illustrated in block 414, the attempted AI based editing of the original multimedia is blocked from presentation on a digital platform.

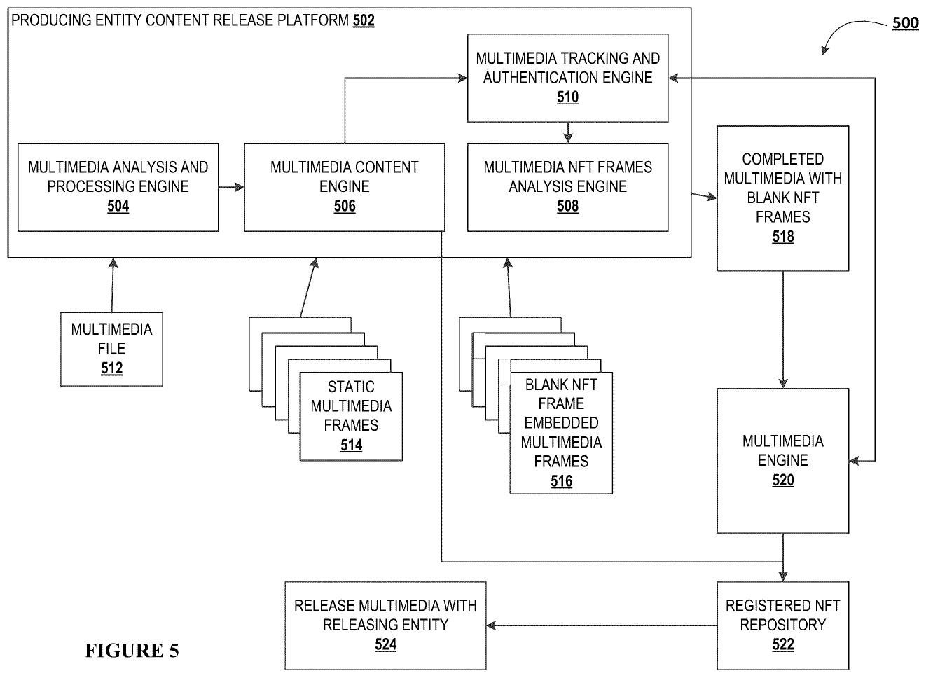

FIG. 5 illustrates a process flow for content allowance using blank NFT frame insertion 500, in accordance with an embodiment of the invention. The producing entity comprises a producing entity content release platform 502 that communicates with the consortium network. The producing entity content release platform 502 may receive multimedia files 512. These may include video files, image files, sound files, or the like. The multimedia files may be divided into static multimedia frames 514 by the producing entity content release platform 502. The producing entity content release platform 502 comprises a multimedia analysis and processing engine 504. The multimedia analysis and processing engine 504 may parse the multimedia file 512 into static multimedia frames 514. The multimedia analysis and processing engine 504 analysis the multimedia for content and confirmation of data presented. Furthermore, the multimedia analysis and processing engine 504 processes the multimedia file 512.

The producing entity content release platform 502 further comprises a multimedia content engine 506. The multimedia content engine 506 reviews each frame of the static multimedia frames 514 and performs a scoring analysis of each frame. Each frame is scored for criticality for the multimedia. This may include frames that have critical messages, critical video portions, or the like. A score is assigned to each frame and the critical frames are identified and parsed out for NFT tagging. The system may identify a specific number of critical frames based on a total number of frames in the multimedia file 512. The multimedia content engine 506 and the multimedia tracking and authentication engine 510 are linked to the registered NFT repository 522. As discussed, the registered NFT repository 522 reviews the content as a check system processing on the content and will parse through existing repository of NFT images and check if the new content is any personal/celebrity/objectionable/unapproved content, in such cases it will not allow blank NFT frames to add new frames.

Referring back to the producing entity content release platform 502, the producing entity content release platform 502 further comprises a multimedia tracking and authentication engine 510 that provides an authentication and verification structure configured to track and authenticate the original multimedia in order to verify a program as described herein represents an improvement over conventional security protocols within multimedia AI tool modification, by moving the verification function to a location not previously used for this purpose/applying a verification function not previously used for this purpose by using blank NFT frame insertion, thereby yielding a tangible technological benefit. Specifically, the claimed system is less vulnerable to AI tool interaction or other similar security threats than conventional systems.

Next, the multimedia NFT frames analysis engine 508 along with the previous steps performed by the producing entity content release platform 502 inserts blank NFT framed embedded into critical parts of the multimedia frames 516. In this way, the producing entity content release platform 502 inserts the blank NFT frames and saves the multimedia. The multimedia with the blank NFT is the only multimedia that leaves the producing entity system. The NFT within the blank NFT frame stores metadata that comprises a location of the blank NFT frame within the multimedia, information about the frames adjacent to the blank NFT frame, and information about the blank NFT frame before and after the blank NFT frame. Furthermore, the NFT comprises metadata regarding a smart contract affiliated with the distributed ledger affiliated with the NFT with rules regarding the timing of launch, releasing entity location, content available for release, and the like.

Next, as illustrated the completed multimedia with blank NFT frames 518 may be transmitted through the consortium network via a multimedia engine 520 that will upload the multimedia. The multimedia engine 520 is in communication with the producing entity content release platform 502 to replace the blank NFT frames with the real multimedia frames prior to release. Each NFT provides a unique identity and ownership that is verifiable via a distributed ledger. The NFT metadata discussed above is processed via a cryptographic hash function. Once the source key is matched and the multimedia engine 520 confirms that the multimedia is the original multimedia, the system communicates with the releasing entity in real time to replace the blank NFT frames with the real frames of the multimedia in order to render a correct multimedia display to an end user.

The invention comprises a system, method, and computer program product for multimedia blank non-fungible token (NFT) frame insertion comprising: accepting an original multimedia file for deployment of a multimedia on a mainstream digital network; segmenting the original multimedia file associated with the multimedia into static frames; selecting a program residing in the distributed computing network based platform for identification of critical static frames within the original multimedia file and remove the critical static frames; replacing the critical static frames with blank NFT frames by inputting the blank NFT frames systematically positioned within static frames of the multimedia content and the critical static frames; storing metadata on an NFT associated with the blank NFT frames for verifying the blank NFT frame; receiving an authentic request to render and release the multimedia; replacing, in real-time the blank NFT frames using a source key from a producing entity across a consortium network; and digitally displaying the multimedia on a releasing entity platform.

In some embodiments, the invention further comprises preventing replacement of the blank NFT frames upon identification of an artificial intelligent (AI) tool attempting to modify the multimedia without the source key, whereby preventing the rendering of the multimedia due to the blank NFT frames.

In some embodiments, after determining the request to render is from the producing entity by authentication of the source code perform a repository check confirming smart contract content approval prior to digital launch of the multimedia.

In some embodiments, the metadata on an NFT associated with the blank NFT frames further comprises information about a location of the blank NFT frame within the multimedia, information about a previous blank NFT frame within the multimedia, information about a future blank NFT frame within the multimedia, and a smart contract.

In some embodiments, the smart contract comprises a content approval mechanism that only allows rendering and releasing of the multimedia within a time and content scope.

In some embodiments, the invention further comprises generation and deployment of the consortium network allowing for a direct communication linkage between a producing entity and a releasing entity to render the multimedia by replacing the blank NFT frames with correct critical static frames for digital release.

In some embodiments, the critical static frames further comprise frames of the multimedia where a critical action or critical message of the overall multimedia occurs within that frame. In some embodiments, the multimedia is a video stream.

Prior to rendering and releasing the multimedia, the system transmits the multimedia through the registered NFT repository 522 to confirm the originality of the multimedia, confirm no manipulation of the multimedia, and confirm satisfaction of smart contracts associated with the multimedia. Finally, as illustrated in block 524, the process 500 is completed by releasing the multimedia with the releasing entity.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F #.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These computer-executable program code portions execute via the processor of the computer and/or other programmable data processing apparatus and create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for multimedia blank non-fungible token (NFT) frame insertion, the system comprising:
a distributed computing network based platform configured for blank NFT frame authentication and deployment;
at least one non-transitory storage device comprising computer program code stored thereon; and
at least one processing device coupled to the at least one non-transitory storage device, wherein the at least one processing device is configured to execute the computer program code to:
accept an original multimedia file for deployment of a multimedia on a mainstream digital network;
segment the original multimedia file associated with the multimedia into static frames;
select a program residing in the distributed computing network based platform for identification of critical static frames within the original multimedia file and remove the critical static frames;
replace the critical static frames with blank NFT frames by inputting the blank NFT frames systematically positioned within static frames of the multimedia content and the critical static frames;
store metadata on an NFT associated with the blank NFT frames for verifying the blank NFT frame;
receive an authentic request to render and release the multimedia;
replace, in real-time the blank NFT frames using a source key from a producing entity across a consortium network; and
digitally display the multimedia on a releasing entity platform.

2. The system of claim 1, further comprising preventing replacement of the blank NFT frames upon identification of an artificial intelligent (AI) tool attempting to modify the multimedia without the source key, whereby preventing the rendering of the multimedia due to the blank NFT frames.

3. The system of claim 1, wherein after determining the request to render is from the producing entity by authentication of the source code perform a repository check confirming smart contract content approval prior to digital launch of the multimedia.

4. The system of claim 1, wherein the metadata on an NFT associated with the blank NFT frames further comprises information about a location of the blank NFT frame within the multimedia, information about a previous blank NFT frame within the multimedia, information about a future blank NFT frame within the multimedia, and a smart contract.

5. The system of claim 4, wherein the smart contract comprises a content approval mechanism that only allows rendering and releasing of the multimedia within a time and content scope.

6. The system of claim 1, further comprising generation and deployment of the consortium network allowing for a direct communication linkage between a producing entity and a releasing entity to render the multimedia by replacing the blank NFT frames with correct critical static frames for digital release.

7. The system of claim 1, wherein the critical static frames further comprise frames of the multimedia where a critical action or critical message of the overall multimedia occurs within that frame.

8. The system of claim 1, wherein the multimedia is a video stream.

9. A computer program product for multimedia blank non-fungible token (NFT) frame insertion, the computer program product comprising a non-transitory computer-readable medium comprising code causing an apparatus to:
accept an original multimedia file for deployment of a multimedia on a mainstream digital network;
segment, using a distributed computing network based platform configured for blank NFT frame authentication and deployment, the original multimedia file associated with the multimedia into static frames;
select a program residing in the distributed computing network based platform for identification of critical static frames within the original multimedia file and remove the critical static frames;
replace the critical static frames with blank NFT frames by inputting the blank NFT frames systematically positioned within static frames of the multimedia content and the critical static frames;
store metadata on an NFT associated with the blank NFT frames for verifying the blank NFT frame;
receive an authentic request to render and release the multimedia;
replace, in real-time the blank NFT frames using a source key from a producing entity across a consortium network; and
digitally display the multimedia on a releasing entity platform.

10. The computer program product of claim 9, further comprising preventing replacement of the blank NFT frames upon identification of an artificial intelligent (AI) tool attempting to modify the multimedia without the source key, whereby preventing the rendering of the multimedia due to the blank NFT frames.

11. The computer program product of claim 9, wherein after determining the request to render is from the producing entity by authentication of the source code perform a repository check confirming smart contract content approval prior to digital launch of the multimedia.

12. The computer program product of claim 9, wherein the metadata on an NFT associated with the blank NFT frames further comprises information about a location of the blank NFT frame within the multimedia, information about a previous blank NFT frame within the multimedia, information about a future blank NFT frame within the multimedia, and a smart contract.

13. The computer program product of claim 12, wherein the smart contract comprises a content approval mechanism that only allows rendering and releasing of the multimedia within a time and content scope.

14. The computer program product of claim 9, further comprising generation and deployment of the consortium network allowing for a direct communication linkage between a producing entity and a releasing entity to render the multimedia by replacing the blank NFT frames with correct critical static frames for digital release.

15. The computer program product of claim 9, wherein the critical static frames further comprise frames of the multimedia where a critical action or critical message of the overall multimedia occurs within that frame.

16. A method for multimedia blank non-fungible token (NFT) frame insertion the method comprising:
accepting an original multimedia file for deployment of a multimedia on a mainstream digital network;
segmenting, using a distributed computing network based platform configured for blank NFT frame authentication and deployment, the original multimedia file associated with the multimedia into static frames;
selecting a program residing in the distributed computing network based platform for identification of critical static frames within the original multimedia file and remove the critical static frames;
replacing the critical static frames with blank NFT frames by inputting the blank NFT frames systematically positioned within static frames of the multimedia content and the critical static frames;
storing metadata on an NFT associated with the blank NFT frames for verifying the blank NFT frame;
receiving an authentic request to render and release the multimedia;
replacing, in real-time the blank NFT frames using a source key from a producing entity across a consortium network; and
digitally displaying the multimedia on a releasing entity platform.

17. The method of claim 16, further comprising preventing replacement of the blank NFT frames upon identification of an artificial intelligent (AI) tool attempting to modify the multimedia without the source key, whereby preventing the rendering of the multimedia due to the blank NFT frames.

18. The method of claim 16, wherein after determining the request to render is from the producing entity by authentication of the source code perform a repository check confirming smart contract content approval prior to digital launch of the multimedia.

19. The method of claim 16, wherein the metadata on an NFT associated with the blank NFT frames further comprises information about a location of the blank NFT frame within the multimedia, information about a previous blank NFT frame within the multimedia, information about a future blank NFT frame within the multimedia, and a smart contract.

20. The method of claim 16, further comprising generation and deployment of the consortium network allowing for a direct communication linkage between a producing entity and a releasing entity to render the multimedia by replacing the blank NFT frames with correct critical static frames for digital release.
